(19) United States
(12) Patent Application Publication
(10) Pub. No.: US 2026/0165332 A1
(43) Pub. Date: Jun. 18, 2026

(54) FOOD PROCESSING MACHINE WITH SEAL

(71) Applicant: VEMAG Maschinenbau GmbH, Verden (DE)

(72) Inventors: Alexander Fahnenspiel, Verden (DE); Oliver Zerbst, Verden (DE); Dirk Mathiebe, Verden (DE); Sven Kohler, Verden (DE)

(21) Appl. No.: 19/425,315

(22) Filed: Dec. 18, 2025

(30) Foreign Application Priority Data
Dec. 18, 2024 (DE) 102024138519.7

(51) Int. Cl. A22C 11/02; F16J 15/02

(52) U.S. Cl. CPC A22C 11/02; F16J 15/025

(57) ABSTRACT

A food processing machine includes a stationary assembly, a dynamic conveyor assembly which is mounted on the stationary assembly so as to be rotatable about a rotation axis. The conveyor assembly is designed to convey a foodstuff through a processing area defined by the dynamic conveyor assembly and the stationary assembly. A seal is located between the stationary assembly and the conveyor assembly and is designed to seal the processing area. The stationary assembly has a substantially circular sealing groove which is arranged coaxially with the rotation axis, and the seal is arranged in the sealing groove, the sealing groove having at least one recess which extends distally in a radial direction. The seal includes at least one anti-rotation device which projects in a radial direction and is designed to extend into the recess of the sealing groove.

### CROSS-REFERENCE TO RELATED APPLICATION

This application claims priority to German Patent Application No. 102024138519.7, filed Dec. 18, 24. The above-mentioned patent application is incorporated herein by reference in its entirety.

### TECHNICAL FIELD

This application relates to a food processing machine, particularly a filling machine. The application further relates to a corresponding seal for such a food processing machine. The food processing machine comprises a stationary assembly and a dynamic conveyor assembly which is mounted on the stationary assembly so as to be rotatable about a rotation axis and is fluidly connected to the stationary assembly and defines together with the stationary assembly a processing area which extends along the rotation axis and is designed to receive a foodstuff, the conveyor assembly being designed to convey the foodstuff through the processing area. The food processing machine also features a seal which is located between the stationary assembly and the conveyor assembly and is designed to seal the processing area. The stationary assembly has a substantially circular sealing groove which is arranged coaxially with the rotation axis, and the seal is arranged in the sealing groove, the sealing groove having at least one recess which extends distally in a radial direction and is designed to provide a disassembly access for removing the seal from the sealing groove. The application further relates to the use of a corresponding seal.

### BACKGROUND

In the field of food processing machinery, particularly filling machines, it is common for these machines to consist of a stationary assembly and a rotating conveyor assembly. These assemblies work together to convey foodstuff through a processing area. German Patent No. DE 10 2021 133 710 B1 discloses such a food processing machine with a stationary assembly and a rotatable conveyor assembly.

Known systems typically include seals positioned between the stationary and rotating assembly in order to seal the processing area and prevent foodstuffs or liquids from escaping. These seals must have an appropriate resistance to the media due to the contact with foodstuffs that occurs in the processing area. According to known technology, these seals are installed in sealing grooves, which are often arranged circularly and coaxially with the rotation axis of the conveyor assembly. Due to the high mechanical stress, the seals must be regularly serviced or replaced. This can be time-consuming and complicated, particularly if the seals are difficult to access or special tools are required.

German Utility Model No. DE 20 2015 100 048 U1 discloses a beverage filling plant with a media rotary distributor which has a shaft seal that is embodied as a T-shaped radial seal with a rotation protection device for sealing a distribution channel of the media rotary distributor.

Despite the considerable progress in the field of food processing machinery, challenges remain in sealing the processing area. One common problem is that the seals do not always provide a reliable seal, which can lead to leaks and contamination. This is primarily due to the dynamic movement of the rotating conveyor assembly and the consequent undesirable movement of the seal together with the conveyor assembly. On the other hand, a correct installation position of the seal is crucial for a reliable seal, which is sometimes not guaranteed with frequent installation and removal. Furthermore, known systems often do not offer easy ways to quickly and efficiently remove and replace the seals, leading to longer downtimes and higher maintenance costs.

It is therefore the object of the present invention to provide a food processing machine that at least partially overcomes the disadvantages of known systems.

### SUMMARY

To address these and other technical objects, the present invention in first embodiments provides a food processing machine. The food processing machine is particularly a filling machine, preferably a vacuum filling machine. In relation to a food processing machine of the type mentioned at the outset, the invention proposes that the seal comprise at least one radially projecting anti-rotation device which is designed to extend into the recess of the sealing groove. The anti-rotation device is embodied in particular as a nose-like projection that is molded onto the circular seal. Because this anti-rotation device protrudes in a radial direction—i.e., toward the center of the circle or outward - it presents an obstacle that effectively prevents the seal from rotating with the conveyor assembly. Even though the rotation of the conveyor assembly exerts forces in the circumferential direction on the seal, the anti-rotation device inhibits the movement, because it is seated in the recess and cannot move out of it. The anti-rotation device is therefore embodied as a radial projection of the seal having sufficient strength that it does not simply break off due to the rotary movement of the conveyor assembly. This anti-rotation feature also makes it easier to remove the seal from the groove, which greatly simplifies maintenance and replacement of the seal and thus reduces downtime. The anti-rotation device forms a projection extending from the sealing groove relative to the rest of the circular seal, enabling the seal to be fixed and removed from the sealing groove manually or with a tool. The arrangement and placement of the seal is further facilitated by the anti-rotation device, whose position is fixed at least in the circumferential direction.

Refinements of the invention and preferred features are explained in the embodiments described below.

According to one embodiment, the stationary assembly has a substantially circular sealing groove which is arranged coaxially with the rotation axis and in which the seal is arranged. The sealing groove has at least one distally extending radially recessed area that is designed to provide a receptacle for receiving the seal and/or disassembly access for removing the seal from the sealing groove.

The seal preferably comprises at least one radially outwardly projecting anti-rotation device which is designed to extend into the recess of the sealing groove. The anti-rotation device preferably has an asymmetrical design. The asymmetrical anti-rotation device ensures targeted and precise positioning of the seal within the sealing groove, which increases the efficiency and reliability of the seal. The asymmetrical shape enables the anti-rotation device to better engage in the recess of the sealing groove, which improves the fit of the seal in the sealing groove during machine operation. This prevents the seal from rotating within the sealing groove even under high torques and the resulting loads on the seal, thereby reducing leakage and improving hygiene, since the foodstuff is conveyed more reliably and effectively through the processing area. Furthermore, the asymmetrical anti-rotation device facilitates the assembly process, as it provides a clear orientation and direction for positioning the seal. The anti-rotation device thus also functions as a coding element which ensures correct installation position. This significantly reduces the effort and time required for maintenance work and minimizes the risk of incorrect seal installation.

According to another embodiment, the sealing groove has an undercut which enables a specific mechanical connection between the sealing groove and the seal. This design offers the advantage that the seal is held securely and firmly in the sealing groove, thus ensuring improved sealing and stability.

The anti-rotation device for the seal preferably comprises a bulge which extends in the circumferential direction of the seal and is designed to engage with the undercut. The bulge is designed and constructed such that the seal can be fixed not only axially but also radially in the food processing machine, which increases operational reliability. Furthermore, a one-sided bulge allows for only one defined mounting position, whereby incorrect installation of the seal is effectively prevented. As the conveyor assembly rotates during operation, the bulge extends farther into the recess, thus ensuring secure positioning of the seal.

Alternatively or in addition, the sealing groove has a chamfered insertion portion which is formed particularly in a transitional region between the annular seal and the anti-rotation device. This is especially advantageous, as it simplifies the assembly process and avoids the risk of incorrect installation of the seal, since only one installation position is possible due to the chamfered insertion portion.

The anti-rotation device of the seal preferably has a corresponding design and has a chamfer which is designed to engage with the chamfered insertion portion. This corresponding design of the anti-rotation device and the chamfered insertion portion ensures precise and reliable positioning of the seal in the sealing groove. This enhances the safety of the processing area, as the seal, by virtue of its positioning in the correct installation position and the corresponding design of the anti-rotation device, more particularly of the undercut or chamfer, provides an improved barrier against the escape of foodstuffs or liquids. This effectively prevents the seal from rotating, since the anti-rotation device engages even farther in the bulge or chamfer due to the rotational movement.

According to another embodiment, the recess and the anti-rotation device are asymmetrically designed, meaning that their geometric shapes and dimensions are not symmetrical. The asymmetrical design of the recess and the anti-rotation device correspond to one another, i.e., are coordinated with each other. This asymmetry ensures that the anti-rotation device can only be received by the recess in a specific installation position. This offers multiple advantages. Firstly, this simplifies and speeds up the installation of the seal, as the asymmetrical shape provides a clear orientation and thus prevents confusion or incorrect installation attempts. The anti-rotation device can only be inserted into the recess in one specific position, which ensures the correct placement of the seal. Secondly, this design increases the operational reliability of the machine, as the seal is fixed in a defined position, thus preventing slippage or mispositioning during operation. This is especially important in order to ensure a reliable sealing of the processing area where the foodstuff is conveyed. The asymmetrical design of the recess and the anti-rotation device thus contributes to preventing leaks and maintaining the hygienic conditions which are essential for the processing of foodstuffs.

According to another embodiment, the sealing groove has at least one first recess and one second recess which is offset by an offset angle relative to the first recess. The offset angle is not equal to 180°. This arrangement of the recesses allows for improved disassembly and assembly of the seal, as the two recesses provide a clear orientation and thus prevent confusion or incorrect installation attempts. The anti-rotation devices can only be inserted into the recesses in a specific position, which ensures the correct placement of the seal. Providing two or more recesses with an offset angle other than 180° also contributes to preventing leaks and maintaining the hygienic conditions which are essential for the processing of foodstuffs.

According to another embodiment, both the recess and the anti-rotation device extend radially outward. The radially outwardly oriented recess provides a clear and accessible way to reach and remove the seal, which greatly simplifies and speeds up maintenance work. At the same time, the radially outwardly oriented anti-rotation device ensures that the seal is held securely in the recess, thus ensuring a reliable sealing of the processing area. This constructive design helps to preserve the integrity of the processing area by minimizing the risk of leaks, thus increasing the efficiency and hygiene of the food processing machine.

According to another embodiment, the recess in a plane whose surface normal forms the rotation axis has a first projection surface, while the anti-rotation device has a second projection surface which is smaller than the first projection surface. This specific design of the projection surfaces allows for a more precise and controlled disassembly of the seal, since a tool for disassembling the seal can be moved into the recess under the anti-rotation device in order to engage in the same. The larger projection surface, and consequently the larger recess, provides ample space for this. This not only makes maintenance and replacement of the seal easier, but also minimizes the risk of damage to the seal or the sealing groove during the disassembly process.

According to another embodiment, the seal and the anti-rotation device are integrally formed. This integral design means that the seal and the anti-rotation device are made from a single piece of material and are not manufactured separately and then joined together. This design allows for improved mechanical stability and a more reliable sealing of the processing area, as there are no potential weak points at the connection points between the seal and the anti-rotation device. This is essential particularly given the high stresses placed on the seal during use in a food processing machine, such as a filling machine. The integrated design simplifies the handling of the seal, since fewer individual parts are required and the risk of loss or damage to individual components is minimized. Furthermore, the manufacture of the seal is made more efficient, since the manufacturing process is simplified and fewer assembly steps are required.

According to another embodiment, the stationary assembly is embodied as a hopper inlet. The hopper inlet ensures that the foodstuff enters the conveyor assembly evenly and in a controlled manner. This conveyor assembly is embodied as a feeder curve for the filling machine, so that it moves the foodstuff along a predetermined path in order to transport it through the processing area. The feeder curve allows for precise control of the movement of the foodstuff, which is especially important in order to ensure even filling and ensure the quality of the final product.

According to another embodiment, the food processing machine is a filling machine, which means that it is specifically designed for portioning foodstuffs or for filling casings, such as artificial or natural intestines, with foodstuffs. It is especially preferably a vacuum filling machine.

The stationary assembly is preferably embodied as a hopper flange. The hopper flange enables efficient feeding of the foodstuff into the conveyor assembly and ensures that the foodstuff reaches the processing area evenly and without spillage. The conveyor assembly is embodied as a conveying means for the filling machine, which indicates that it has the function of transporting the foodstuff through the processing area. The conveying device is preferably a pump, which indicates that it is a mechanical device that moves the foodstuff by creating a pressure differential. The pump ensures a continuous and controlled flow of the foodstuff, which is crucial for the even filling of containers or cavities. Communication between the components takes place via the fluid-conducting connection between the stationary assembly and the conveyor assembly, which ensures that the foodstuff travels without interruption from the hopper flange to the pump and finally into the processing area. The seal, which is located between the stationary assembly and the conveyor assembly, plays a crucial role in maintaining hygiene and preventing leaks. The sealing groove, which is arranged coaxially with the rotation axis, and the seal located therein with the radially extending anti-rotation device which engages in the recess of the sealing groove, ensure a reliable sealing of the processing area.

According to another embodiment, the seal has a first height in the axial direction, and the sealing groove has a second height in the axial direction which is smaller than the first height, so that axial forces act on the seal through the stationary assembly and the conveyor assembly. The different heights of the seal and the sealing groove ensure that the seal is compressed in the axial direction when the stationary assembly and the conveyor assembly are assembled. This compression results in an improved sealing of the processing area, since the seal is pressed firmly against the inner walls of the sealing groove by the axial forces. This minimizes the risk of leaks, which is especially important in order to ensure the hygiene and efficiency of the food processing machine. Furthermore, the arrangement of the seal with a greater height than the sealing groove allows for easy and effective disassembly and maintenance. When the conveyor assembly is separated from the stationary assembly, the seal relaxes and can be easily removed from the sealing groove, particularly in conjunction with the at least one distally extending radial recess, which provides disassembly access. In other words, the seal is preferably embodied as a type of compression seal which is designed to protrude slightly from a corresponding sealing groove when in use, so that when the food processing machine is closed through coupling of the stationary assembly and the conveyor assembly, the seal experiences axial forces, which enables the seal to fill the sealing groove even better and improves the sealing effect.

According to another embodiment, the seal has a first height in a radial direction, and the sealing groove has a second height in a radial direction which is smaller than the first height, so that radial forces act on the seal through the stationary assembly and the conveyor assembly. The different heights of the seal and the sealing groove ensure targeted compression of the seal when it is inserted into the sealing groove. This compression ensures that the seal is seated securely in the groove, thus ensuring an effective sealing of the processing area. The radial forces exerted on the seal by the stationary assembly and the rotating conveyor assembly further contribute to the stability and tightness of the connection. This is especially important in order to prevent foodstuffs or liquids from escaping from the processing area, which increases the hygiene and efficiency of the food processing machine. Furthermore, the arrangement of the seal with a greater height than the sealing groove allows for easy disassembly and maintenance. The seal can be easily removed through the recess in the sealing groove without the need for special tools or complicated procedures. This reduces machine downtime and facilitates cleaning and replacement of the seal, which in turn extends the machine's lifespan and reduces operating costs. In other words, the seal is preferably embodied as a type of compression seal which is designed to protrude slightly from a corresponding sealing groove when in use, so that when the food processing machine is closed through coupling of the stationary assembly and the conveyor assembly, the seal experiences radial forces, which enables the seal to fill the sealing groove even better and improves the sealing effect.

Preferably, the seal is embodied as an axial seal. The axial seal is designed to seal along the rotation axis, which means that it ensures an improved seal along the rotation axis of the dynamic conveyor assembly and the stationary assembly. The axial seal ensures that the processing area, which is designed to receive and convey the foodstuff, remains effectively sealed, even under the dynamic conditions of rotation. This helps to prevent leaks and ensures compliance with hygiene requirements in food processing. Furthermore, the axial alignment of the seal facilitates assembly and disassembly, since it can be moved along the axis of the machine, which reduces maintenance and increases the machine's operating time.

According to another embodiment of the food processing machine, the recess has a rounded concave shape. The rounded concave shape of the recess makes disassembly of the seal considerably easier, as it provides access to the seal. This reduces the risk of damage to the seal during the removal process, as sharp edges or corners that could tear or deform the seal are avoided. Furthermore, the rounded shape allows for easier cleaning by avoiding corners which are more difficult to access and in which foodstuff could accumulate. This is especially important in industrial applications in which machines need to be frequently cleaned and maintained in order to meet hygiene standards. The rounded shape of the recess can also extend the service life of the seal, since it is less susceptible to wear and tear and damage that could be caused by uneven pressure distribution or mechanical stress. Furthermore, the rounded concave shape of the recess can simplify the manufacture and assembly of the food processing machine, as it requires less precise tolerances and can therefore reduce production costs.

According to another preferred embodiment, the seal has a material thickness in the axial direction that is adapted to the acting torque between the rotating assembly and the stationary assembly. Accordingly, the anti-rotation device also has a material thickness in the axial direction that is adapted to the acting torque between the rotating assembly and the stationary assembly. The material thickness should be selected such that the anti-rotation device cannot be torn off from the rest of the seal during operation.

The present invention in second embodiments provides a seal. This seal is designed for installation in a food processing machine, particularly in a food processing machine according to the first aspect of the invention. The seal is substantially circular in shape and has a sealing material which is such that the seal is designed to be received in a substantially circular sealing groove of the food processing machine between a stationary assembly and a rotatably mounted conveyor assembly. The seal comprises at least one radially projecting anti-rotation device which is specifically designed to extend into a corresponding recess in the sealing groove into which the seal can be inserted. If such a recess is not available, the anti-rotation device can also be clamped between the two parts to be sealed. The anti-rotation device is made of a sealing material with an appropriate strength that enables it to absorb the forces occurring during the operation of a food processing machine, in particular of a filling machine, without the anti-rotation device breaking off. This anti-rotation device plays a crucial role in ensuring a tight seal by preventing relative movement of the seal in the circumferential direction. Furthermore, the anti-rotation device extending into the recess of the sealing groove facilitates disassembly. This means that the seal can be removed more easily during maintenance or in the event of a replacement by fixing the seal to the anti-rotation device and then moving it out of a sealing groove in which it is held. By virtue of its anti-rotation feature, the seal takes advantage of the advantages described above.

The seal is particularly a filling machine seal. Such a filling machine seal is preferably made of a food-grade material.

The present invention also includes using a seal as described above in a food processing machine also as described above. The invention according to these embodiments takes advantage of the benefits described in relation to the first aspect of the invention by using the seal with anti-rotation device. Advantages and preferred embodiments of the food processing machine and, in particular, of its seal according to the embodiments described above of the invention also constitute advantages and preferred embodiments of the use. In particular, the invention further relates to the use of a radially projecting projection of a circular seal as an anti-rotation device for use in a filling machine for sealing a processing area formed by a stationary assembly and a rotatable conveyor assembly.

### BRIEF DESCRIPTION OF THE DRAWINGS

Various embodiments of the present invention will be described in greater detail below on the basis of preferred exemplary embodiments with reference to the enclosed figures.

FIG. 1 is a perspective view of a food processing machine according to one preferred embodiment.

FIG. 2a is a top view of a first section of the food processing machine according to FIG. 1.

FIG. 2b is a cross-sectional side view of the section of the food processing machine according to FIG. 2a.

FIG. 3a is a top view of a second section of the food processing machine according to FIG. 1.

FIG. 3b is a cross-sectional side view of the section of the food processing machine according to FIG. 3a.

FIG. 4a is a top view of the section of the food processing machine according to FIG. 3a with an installed seal.

FIG. 4b is a detailed view of an identified portion of the section of the food processing machine according to FIG. 4a.

FIG. 5a is another top view of the section of the food processing machine according to FIG. 4a with the seal installed.

FIG. 5b is a detailed view of an identified portion of the section of the food processing machine according to FIG. 5a.

FIG. 6a is a top view of a section of the seal according to one preferred embodiment.

FIG. 6b is a top view of a section of the seal according to another preferred embodiment.

FIG. 7a shows a top view of an entirety of the seal according to FIG. 6b.

FIG. 7b shows a cross-sectional side view of the seal according to FIG. 7a.

FIG. 7c is a detailed view of an identified portion of the section of the seal according to FIG. 7b.

### DETAILED DESCRIPTION

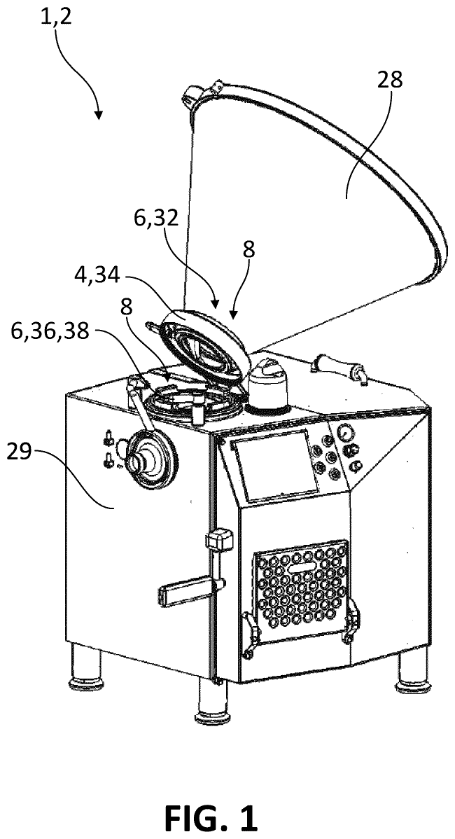

FIG. 1 shows a food processing machine 1, in particular a filling machine 2. The food processing machine 1 consists of a stationary assembly 4 and a dynamic conveyor assembly 6 which is mounted on the stationary assembly 4 so as to be rotatable about a rotation axis RA. The conveyor assembly 6 is fluidly connected to the stationary assembly 4 and defines together therewith a processing area 8 which extends along the rotation axis RA and is designed to receive a foodstuff. The conveyor assembly 6 is designed to convey the foodstuff through the processing area 8.

The filling machine 2 includes a hopper 28, which serves as an inlet for the foodstuff to be processed.

The stationary assembly 4 comprises a hopper flange 34 through which the hopper 28 is attached to the lower housing part 29. The food processing machine 1 is mounted on a stable lower housing part 29 which contains operating elements and a display for controlling and monitoring the processes. The food processing machine 1 stands on adjustable feet which allow for stable positioning and adaptation to uneven surfaces.

The conveyor assembly 6 comprises a feeder curve 32 which is arranged in the hopper 28, and a conveying device 36. The conveying device 36 is embodied in particular as a pump 38 and is arranged in the lower housing part 29. These components work together to efficiently transport the foodstuff through processing area 8.

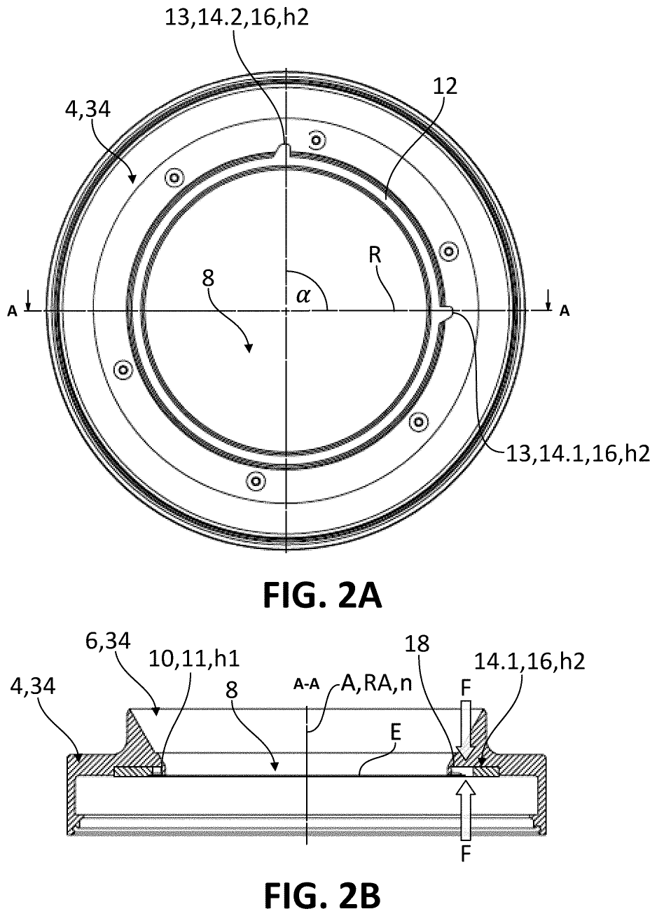

At least one seal 10 (not shown in FIG. 1) is located between the stationary assembly 4 and the conveyor assembly 6 in order to seal the processing area 8. The stationary assembly 4 has in at least one position a substantially circular sealing groove 12 which is arranged coaxially with the rotation axis RA and in which the seal 10 is arranged, as explained in detail below in relation to FIGS. 2 to 7.

FIG. 2a and FIG. 2b show a section of the food processing machine 1 in the vicinity of the stationary assembly 4, in particular of a hopper flange 34. FIG. 2a shows a top view, and FIG. 2b shows a cross section of the food processing machine 1 along the line I-I from FIG. 2a.

The conveyor assembly 6 is fluidly connected to the stationary assembly 4; together they define the processing area 8, which is designed to receive a foodstuff. The conveyor assembly 6 is designed to convey the foodstuff through the processing area 8.

The stationary assembly 4 is embodied as a hopper flange 34, and the rotatable conveyor assembly 6 is embodied as a feeder curve 32.

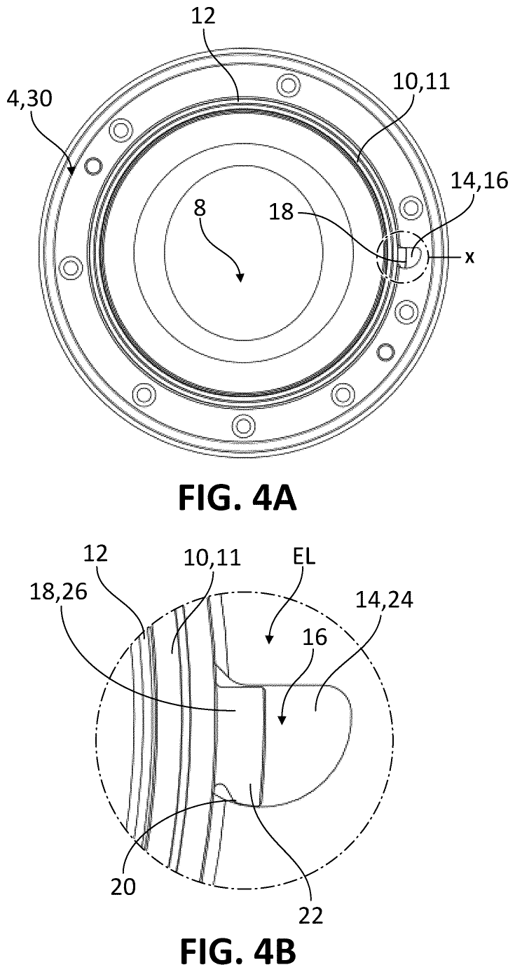

The stationary assembly 4 is arranged coaxially with the rotation axis RA and has a substantially circular sealing groove 12. The sealing groove 12 contains at least one recess, preferably two recesses 14.1, 14.2, which extend distally in a radial direction R and each provide a disassembly access 16 for removing a seal 10 contained therein (see FIGS. 4a to 7c). The seal 10 indicated in FIG. 2b in the first recess 14.1 comprises at least one anti-rotation device 18 which projects in a radial direction R and extends into the first recess 14.1 of the sealing groove 12. The second recess 14.2 is preferably identical to the first recess 14.1. The recesses 14.1, 14.2 and the anti-rotation devices 18 have an asymmetrical design, so that the anti-rotation devices 18 each fit into the recess 14 recesses 14.1, 14.2 only in a specific installation position EL. The first recess 14.1 and the second recess 14.2 are offset by an offset angle α relative to the first recess 14.1, the offset angle α being not equal to 180°.

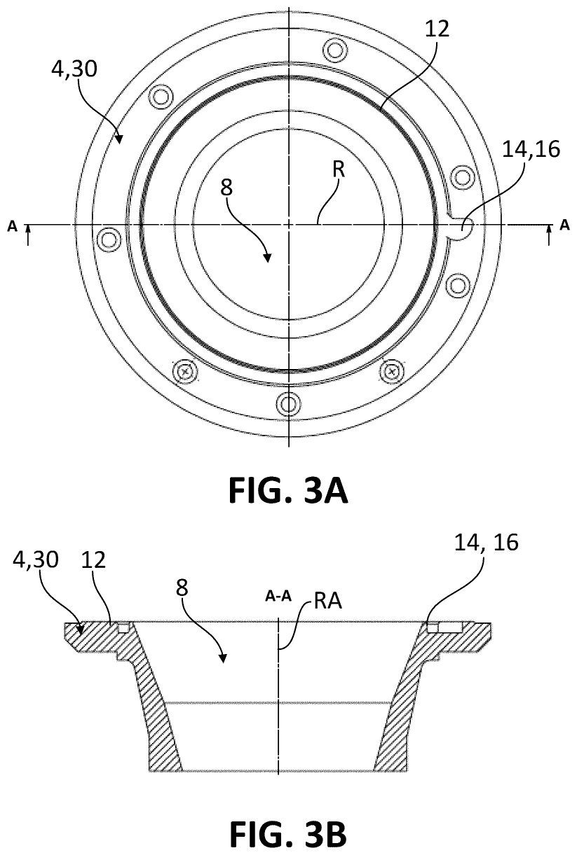

FIG. 3a and FIG. 3b show a section of the food processing machine 1 in the vicinity of the stationary assembly 4, in particular in the vicinity of a hopper flange 34. FIG. 3a shows a top view, and FIG. 3b shows a cross section of the food processing machine 1 along the line I-I from FIG. 3a.

The stationary assembly 4 is embodied as a hopper inlet 30 and comprises a substantially circular sealing groove 12 which is arranged coaxially with the rotation axis RA. The sealing groove 12 runs in a circle around the processing area 8. The sealing groove 12 extends along the rotation axis RA. The sealing groove 12 has at least one recess 14 which extends distally in a radial direction R and is designed to provide a disassembly access 16 for removing a seal 10 (see FIGS. 4a to 7c) contained therein from the sealing groove 12. The recess 14 has an asymmetrical design, which necessitates a specific installation position EL of the seal.

The sealing groove 12 and the recess 14 are designed to enable efficient sealing and easy disassembly of the seal. The recess 14 provides sufficient space to remove the seal from the groove without compromising the integrity of the seal or of the assembly.

The stationary assembly group 4 is designed to enable reliable and hygienic food processing. The hopper inlet 30 conducts the foodstuff into the processing area 8, where it is transported further by the rotating conveyor assembly. The sealing groove 12 and the seal 10 ensure that the processing area 8 remains sealed in order to prevent contamination of the foodstuff and to ensure the efficiency of the food processing machine 1.

FIG. 4a shows a top view of the section of the food processing machine 1 according to FIG. 3a with a seal 10 which is received in the sealing groove 12 of the hopper inlet 30. FIG. 4b shows a detailed illustration.

The seal 10 is embodied as an axial seal 11 and comprises at least one radially outward extending anti-rotation device 18 which projects into a recess 14 of the sealing groove 12. This recess 14 serves as a disassembly access 16 for removing the seal 10 from the sealing groove 12.

The seal 10 serves to seal the processing area 8, which extends along the rotation axis RA. The seal 10 is preferably integrally formed with the anti-rotation device 18, which extends outward in radial direction R and projects into the recess 14 of the sealing groove 12.

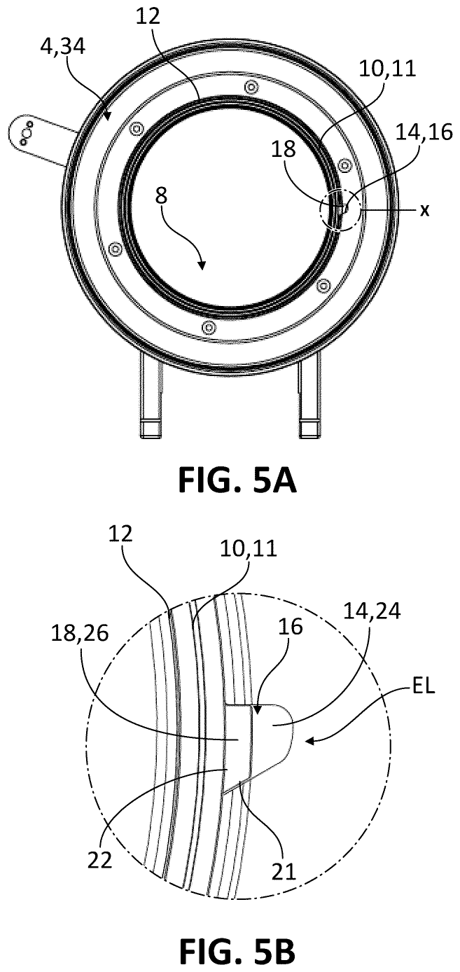

The recess 14 has an undercut 20, and the anti-rotation device 18 of the seal 10 has a circumferentially extending bulge 22 which engages with the undercut 20. Alternatively, the sealing groove 12 can have a chamfered insertion portion 21 (see FIG. 5a and FIG. 5b), and the anti-rotation device 18 can have a correspondingly shaped bulge 22 which engages with the chamfered insertion portion 21.

In a plane E, whose surface normal n forms the rotation axis RA (see FIG. 2b), the recess 14 has a first projection surface 24, and the anti-rotation device 18 has a second projection surface 26 which is smaller than the first projection surface 24.

FIG. 4b shows an enlarged detailed view of the sealing groove 12 and the seal 10 from FIG. 4a. This detailed view shows the recess 14 and the anti-rotation device 18 in detail. The recess 14 extends distally in radial direction R and forms the disassembly access 16. The seal 10 has the anti-rotation device 18, which has an asymmetrical design and extends into the recess 14. The anti-rotation device 18 is designed such that it can only be received in a specific installation position EL by the recess 14.

The sealing groove 12 also has the undercut 20, which engages with a bulge 22 of the anti-rotation device 18 extending in the circumferential direction of the seal 10. This bulge 22 is designed to ensure a secure connection between the seal 10 and the sealing groove 12.

FIG. 5a shows a top view of the food processing machine 1 in the vicinity of the stationary assembly 4, particularly of a hopper flange 34.

Located in the middle of the hopper flange 34 is the processing area 8, which is defined by the rotatable conveyor assembly (not shown) and the stationary assembly 4. The sealing groove 12 is arranged coaxially with the rotation axis RA and has a substantially circular shape. The seal 10, which is embodied as an axial seal 11, is arranged within the sealing groove 12. The seal 10 comprises at least one anti-rotation device 18 which projects outward in a radial direction R and extends into a recess 14 of the sealing groove 12. This recess 14 provides a disassembly access 16 which enables the seal 10 to be removed from the sealing groove 12.

FIG. 5b shows an enlarged detailed view of the area around the recess 14 and the anti-rotation device 18. The recess 14 extends distally in radial direction R and has an asymmetrical design, so that the anti-rotation device 18 only fits into the recess 14 in a specific installation position EL. The anti-rotation device 18 has a bulge 22 with a chamfered side surface which is designed to engage with a chamfered insertion portion 21 of the sealing groove 12. This bulge 22 enables the seal 10 to be securely fixed within the sealing groove 12 through engagement with the undercut 20 of the sealing groove 12.

The seal 10 and the anti-rotation device 18 are integrally formed, which ensures a uniform and robust structure.

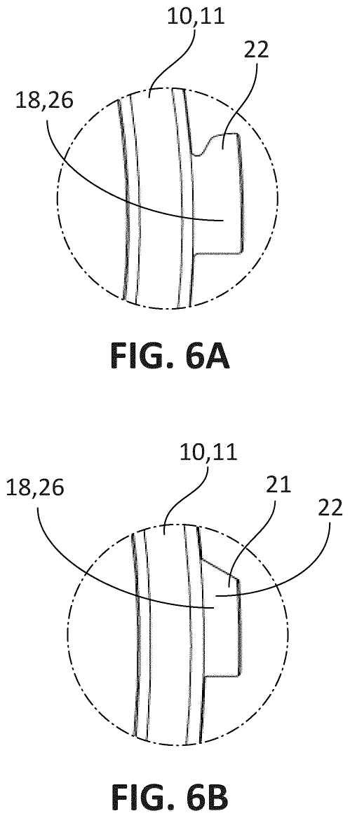

FIG. 6a and FIG. 6b show detailed views of a seal 10, 11 used in a food processing machine 1. This seal is specifically designed for sealing a processing area in a rotating conveyor assembly.

FIG. 6a and FIG. 6b show the seal 10, 11 with integrated anti-rotation device 18. This anti-rotation device extends in a radial direction and is designed to engage in a corresponding recess of the sealing groove. The seal 10, 11 is designed to ensure a reliable seal between the stationary assembly and the rotating conveyor assembly.

The anti-rotation device 18 has an asymmetrical design, which is illustrated in the figures by the different shape and position of the anti-rotation device. This asymmetry ensures that the seal can only be correctly installed in a specific mounting position, which facilitates assembly and disassembly while simultaneously optimizing the sealing function.

In FIG. 6a, the anti-rotation device 18 according to FIG. 4a and FIG. 4b is shown in isolation. The anti-rotation device 18 has the bulge 22 and extends in the vicinity of a projection surface 26. This bulge 22 extends in the circumferential direction of the seal 10 and is designed to engage with an undercut 20 (see FIG. 4 a and FIG. 4b) of the sealing groove 12. This configuration enables the seal 10 to be securely fastened in the groove 12 and prevents unintentional loosening during the operation of the food processing machine 1.

In FIG. 6b, the anti-rotation device 18 according to FIG. 5a and FIG. 5b is shown in isolation. Visible here as well is the anti-rotation device 18 with the bulge 22 which is designed to engage in a chamfered insertion portion 21 of the sealing groove (see FIG. 5b).

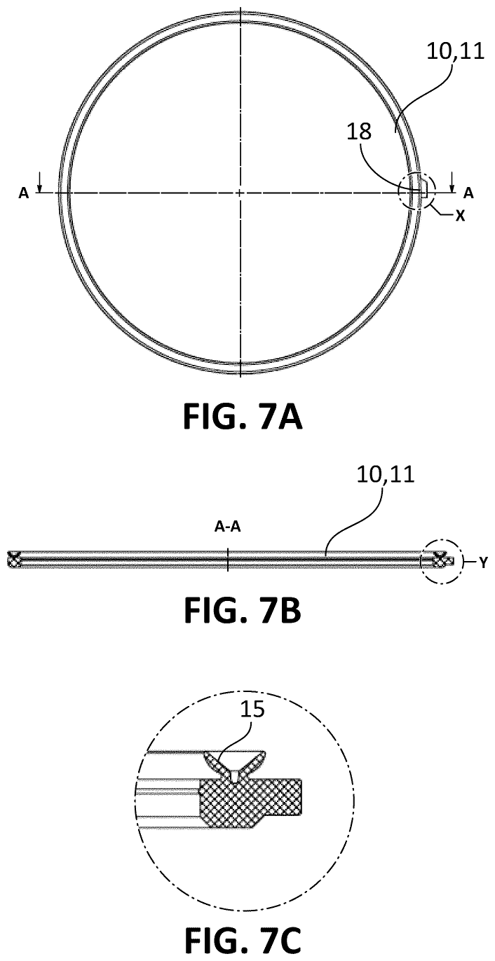

FIG. 7a illustrates a top view of the seal 10 embodied as an axial seal 11 which is arranged in a substantially circular sealing groove (not shown). The seal 10 has an anti-rotation device 18 which extends outward in a radial direction R. This anti-rotation device 18 is designed to engage in a corresponding recess (not shown) of the sealing groove. There may also be more than two anti-rotation devices 18 with identical or varying designs.

FIG. 7b shows a cutaway side view of the seal 10 along the line A-A from FIG. 7a. This view illustrates the axial extension of the seal 10 and shows the formation of a sealing lip 15 of the seal 10. The extension of the anti-rotation device 18 along the radial direction is also shown. The sealing lip 15 is also shown in detail in FIG. 7c.

The sealing lip 15 of the seal 10 points upward in the view shown, and the correct installation position EL is essential in order for the sealing lip 15 to perform its function. This is ensured by the anti-rotation device 18 and the correspondingly designed recess 14.

The embodiments described above are only descriptions of preferred embodiments of the present invention, and are not intended to limit the scope of the present invention. Various variations and modifications can be made to the technical solution of the present invention by those of ordinary skills in the art, without departing from the design and spirit of the present invention. The variations and modifications should all fall within the claimed scope defined by the claims of the present invention.

What is claimed is:

1. A food processing machine, comprising:
a stationary assembly,
a dynamic conveyor assembly which is mounted on the stationary assembly so as to be rotatable about a rotation axis and is fluidly connected to the stationary assembly and defines together with the stationary assembly a processing area which extends along the rotation axis and is designed to receive a foodstuff, wherein the conveyor assembly is designed to convey the foodstuff through the processing area,
a seal which is located between the stationary assembly and the conveyor assembly and is designed to seal the processing area,
wherein the stationary assembly has a substantially circular sealing groove which is arranged coaxially with the rotation axis, and the seal is arranged in the sealing groove, the sealing groove having a recess which extends distally in a radial direction and is designed to provide a disassembly access for removing the seal from the sealing groove, and
wherein the seal is an axial seal and comprises at least one anti-rotation device which projects in a radial direction and is designed to extend into the recess of the sealing groove.

2. The food processing machine according to claim 1, wherein at least one anti-rotation device has an asymmetrical design.

3. The food processing machine according to claim 1,
wherein the sealing groove has an undercut, and the at least one anti-rotation device has a bulge which extends in a circumferential direction of the seal and is designed to engage with the undercut, or
wherein the sealing groove has a chamfered insertion portion, and the at least one anti-rotation device has a correspondingly shaped bulge which is designed to engage with the chamfered insertion portion.

4. The food processing machine according to claim 1, wherein the recess and the at least one anti-rotation device have an asymmetrical design which is such that the at least one anti-rotation device can be received by the recess exclusively in one installation position.

5. The food processing machine according to claim 1, wherein the recess is a first recess and the sealing groove has a second recess which is offset by an offset angle relative to the first recess, wherein the offset angle being not equal to 180°.

6. The food processing machine according to claim 1, wherein the recess and the at least one anti-rotation device extend outward in a radial direction.

7. The food processing machine according to claim 1, wherein, in a plane whose surface normal forms the rotation axis, the recess has a first projection surface, and the at least one anti-rotation device has a second projection surface which is smaller than the first projection surface.

8. The food processing machine according to claim 1, wherein the seal and the at least one anti-rotation device are integrally formed.

9. The food processing machine according to claim 1, wherein the food processing machine is a filling machine, the stationary assembly is embodied as a hopper inlet, and the conveyor assembly is embodied as a feeder curve of the filling machine.

10. The food processing machine according to claim 1, wherein the food processing machine is a filling machine, the stationary assembly is embodied as a hopper flange, and the conveyor assembly is embodied as a pump of the filling machine.

11. The food processing machine according to claim 1, wherein the seal has a first height in an axial direction, and the sealing groove has a second height in the axial direction which is smaller than the first height, so that axial forces act on the seal through the stationary assembly and the conveyor assembly.

12. The food processing machine according to claim 1, wherein the seal has a first height in a radial direction, and the sealing groove has a second height in a radial direction which is smaller than the first height, so that radial forces act on the seal through the stationary assembly and the conveyor assembly.

13. The food processing machine according to claim 1, wherein the recess has a rounded concave shape.

14. A seal for a food processing machine,
wherein the seal is substantially circular in shape and comprises a sealing material which is such that the seal is designed to be received in a substantially circular sealing groove between a stationary assembly and a rotatably mounted conveyor assembly and to seal a processing area, and
wherein the seal is an axial seal and comprises at least one anti-rotation device which projects in a radial direction and is designed to extend into a corresponding recess of the sealing groove in a food processing machine.
